(19) United States
(12) Patent Application Publication
(10) Pub. No.: US 2006/0238484 A1
(43) Pub. Date: Oct. 26, 2006

(54) DISPLAY

(76) Inventors: Chuan-Pei Yu, I-Lan Hsien (TW); Ming Chuan Chou, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,324

(22) Filed: Sep. 7, 2005

(30) Foreign Application Priority Data
Apr. 25, 2005 (TW) 094113118

(51) Int. Cl. G09G 3/36

(52) U.S. Cl. 345/102

(57) ABSTRACT

A display includes a flat display panel and at least a polarizer positioned on an upper surface or a lower surface of the flat display panel. The polarizer has at least a surface treated with a roughness treatment.

### BACKGROUND OF THE INVENTION

1. Field of the Invention

The present invention relates to a display, and more particularly, to a display, which can reduce the optical interference in a picture produced by the display.

2. Description of the Prior Art

Portable intelligent information products are becoming increasingly popular while the technology changes with each passing day. The display plays an important role as a medium between human beings and machines. The LCD module has a thin shape, low power consumption, a small divergence, etc, which makes the LCD module useful for applications such as portable intelligent information products (ex: notebooks, PDAs, and cellular phones . . . ). The LCD module has a huge market share with consumer information products, and is gradually replacing the desktop computer CRT monitor and the traditional TV.

In general, a LCD module comprises a liquid crystal display panel, a light source, a light guide plate, and several kinds of optical films. Please refer to FIG. 1. FIG. 1 is a cross-section diagram of a LCD module 10 according to the prior art. As FIG. 1 shows, the LCD module 10 comprises a liquid crystal display panel 12 and a back light module 14. In general, the liquid crystal display panel 12 comprises two glass substrates and a liquid crystal layer between the glass substrates. xxxxx The back light module 14 comprises a light source (not shown), a light guide plate 16, and a plurality of optical films, such as the diffusion film 18 and two prisms 20, 22 shown in FIG. 1, wherein there are pluralities of diamond pillars or half-cylinder patterns, perpendicularly aligned in a matrix array, formed on the surface of prism 20 and the surface of prism 22. The function of the prisms 20, 22 is for controlling the light angle of the back light module, centralizing the light angle, and providing a better light source to the liquid crystal display panel 12. However, the color filters and TFTs of the liquid crystal display panel 12 are strip arrays. When light passes through the prism light guide plate and prisms 20, 22 into the liquid crystal display panel 12, the moiré effect and other optical problems will occur due to the structure of the prisms 20, 22. Otherwise, if the prisms 20, 22 are smooth films, interference problems, such as the moiré effect and the Newton's Ring effect, will easily occur. The above-mentioned optical problems cause a worse quality picture, and are especially noticeable in large sided displays.

These problems have forced the display manufacturers to display misalignment of patterns of the prisms 20, 22 in order to reduce the optical interference problem. However, this design increases the cost of the prisms 20,22. That is why finding a simple effective way to solve the optical interfere problem of the display is the point of the present invention.

### SUMMARY OF THE INVENTION

The main purpose of the present invention relates to providing a display having a diffusion layer, wherein the diffusion layer formed on an upper surface or a lower surface of a flat display panel to solve the above-mentioned optical problem.

According to the claimed invention, a display comprises a flat display panel, and at least one polarizer formed on an upper surface of the flat display panel or a lower surface of the flat display panel, the polarizer having at least one rough surface.

According to the claimed invention, a display module comprises an upper transparent substrate, a lower transparent substrate, which is parallel with and is beneath the upper transparent substrate, a liquid crystal layer formed between the upper transparent substrate and the lower transparent substrate, an upper polarizer adhered to an upper surface of the upper transparent substrate by an upper adhesive, and a lower polarizer adhered to a lower surface of the lower transparent substrate by a lower adhesive. The upper adhesive or the lower adhesive is a diffusing adhesive, which is able to scatter light.

According to the claimed invention, a method of reducing an optical interference of a display is introduced. The display comprises a flat display panel and a back light module under the flat display panel, and the back light module comprises at least an optical diaphragm, such as a prism. The method comprises providing a diffusion layer on an upper surface of the flat display panel or a lower surface of the flat display panel to scatter light from the back light module and to solve the optical interference problem.

The present invention has a diffusion layer on the upper or lower surface of the flat display. For example, the polarizer has the rough surface or the diffusion layer has the diffusing adhesive. Therefore, the light from the back light module is scattered, so that the optical interfere (ex: the moiré and the Newton's Ring) is reduced, and the picture quality is improved, too.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-section diagram of a LCD module according to the prior art.

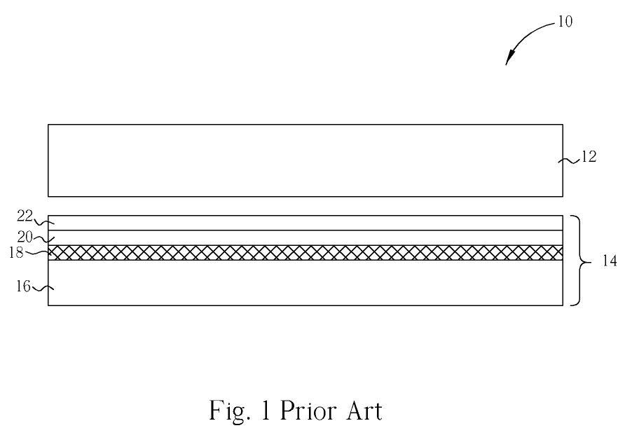

FIG. 2 is a cross-section diagram of a display according to the first embodiment of the present invention.

FIG. 3 is a cross-section diagram of a display according to the second embodiment of the present invention.

FIG. 4 is a diagram of a display module according to the third embodiment of the present invention.

FIG. 5 is a cross-section of a display module according to the fourth embodiment of the present invention.

FIG. 6 is a cross-section diagram of a display module according to the fifth embodiment of the present invention.

### DETAILED DESCRIPTION

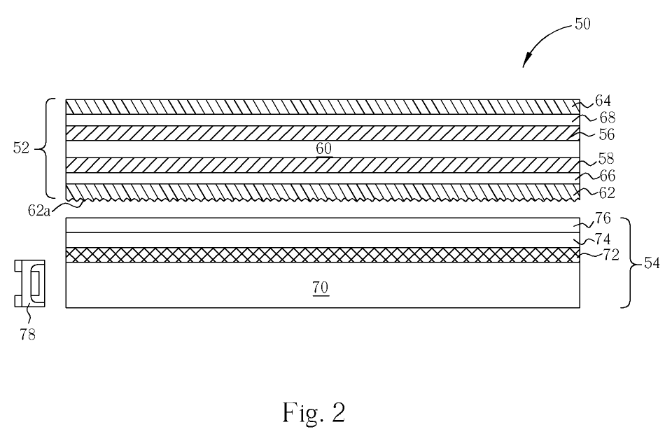

Please refer to FIG. 2. FIG. 2 is a cross-section diagram of a display 50 according to the first embodiment of the present invention. The display 50 comprises a flat display panel 152 and a back light module 54. The back light module 54 has a light source 78, a light guide plate 70, and a plurality of optical diaphragms, which individually are diffusion film 72 and two prisms 74, 76 having perpendicular patterns with each other. The light source 78, which is an LED chip or a traditional light, produces light. The light guide plate 70 guides the path of the light, and the light is scattered into the whole light guide plate 70. In the first embodiment, the light guide plate 70 has prism functionality. The diffusion film 72 can further scatter light, and the emitted light from the emitted light surface of the light guide plate 70 is more uniform. The illumination and luminance of the back light module 54 are increased by the pillar pattern surface of the prisms 74, 76.

The flat display panel 152 comprises an upper transparent substrate 56, a lower transparent substrate 58, a liquid crystal layer 60 between the upper transparent substrate 56 and the lower transparent substrate 58, an upper polarizer 64 and a lower polarizer 62. The upper polarizer 64 and the lower polarizer 62 adhere to the upper surface of the upper transparent 56 with an upper adhesive 68 and the lower surface of the lower transparent substrate 58 with a lower adhesive 66 individually. The upper transparent substrate 56 and the lower transparent substrate 58 are made from nonconductors such as quartz or glass. The penetration axis of the upper polarizer 64 is perpendicular to the penetration axis of the lower polarizer 62. Please note that a diffusion layer is provided under the lower surface of the flat display panel 52 in the first embodiment to improve the optical interfere problem of the flat display panel 52. That means a rough lower surface 62a of the lower polarizer 62 is made with a rough process, for scattering light. Hence, when light is emitted out and passes into the flat display panel 152, the light will pass through the rough lower surface 62a of the lower polarizer 62, and the rough lower surface 62a will reduce the optical interfere by changing the light path, and the quality of the display 50 picture will thereby be improved.

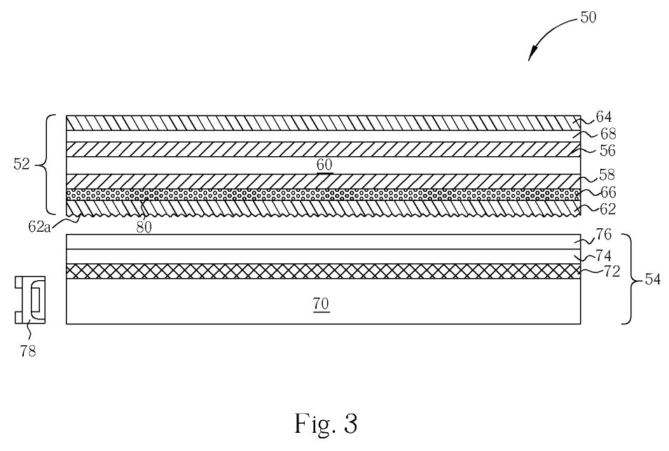

In the second embodiment of the present invention, spread particles 80 are added into the transparent lower adhesive 66 to make the lower adhesive 66 become a diffusing adhesive that can scatter light for increasing the scatter light function of the polarizer 62, and the optical interfere problem improves. Please refer to FIG. 3. FIG. 3 is a cross-section diagram of a display 50 according to the second embodiment of the present invention. For convenient explanation, like components of FIG. 3 continue to use the reference numbers used in FIG. 2. The lower polarizer 62 adheres with the lower surface of the lower transparent substrate 58 by the lower adhesive 66. There are a plurality of spread particles 80 in the lower adhesive 66 that adjust the shape, size and index of reflection of the spread particle 80 or the density of the lower adhesive 66 to control the scattering light effect. The scattering light from the lower surface of the lower polarizer 62 is therefore more scattered. The optical interference is reduced, and the possible moire and the Newton's Ring are removed from the display picture.

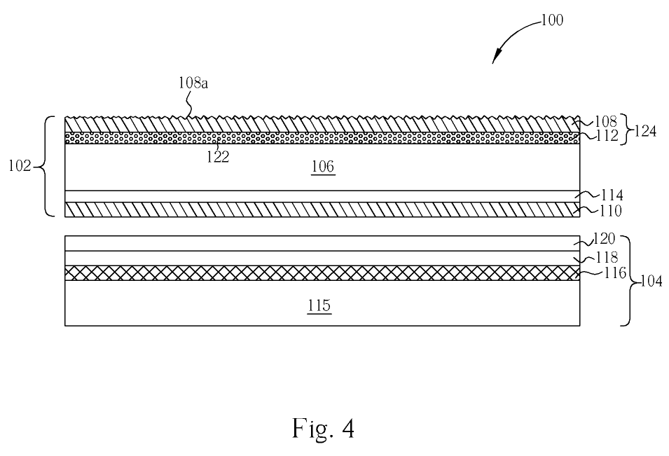

Please refer to FIG. 4. FIG. 4 is a diagram of a display module 100 according to the third embodiment of the present invention. The display module 100 comprises a first part 102 and a second part 104. The first part 102 is a flat display panel 106, which comprises an upper glass substrate, a lower glass substrate, a liquid crystal layer, an upper polarizer 108 on the upper lateral of the flat display panel, and a lower polarizer 110 on the lower lateral of the flat display panel. The upper polarizer 108 is adhered to the surface of the flat display panel 106 by the upper adhesive 112, and the lower polarizer 110 is adhered to the surface of the flat display panel 106 by the lower adhesive 114. The second part 104 comprises a back light module, which comprises a light source (not shown), a light guide plate 115, a diffusion film 116, and two prisms 118, 120.

In the third embodiment, an upper surface 108a of the upper polarizer 108 undergoes a rough process, so the upper surface 108a is rough. Otherwise, the upper adhesive 112 is a diffusing adhesive, which can scatter light. The manufacture of the diffusing adhesive is performed by doping the spread particles 122 with light-scattering function into the general adhesive to achieve the scatter light effect. Because the rough surface 108a of the upper polarizer 108 in the display module 100 has the upper adhesive 112, together they make a diffusion layer 124 to reduce interference stripes, for increasing the quality of the picture by scattering the light from the liquid crystal layer gently.

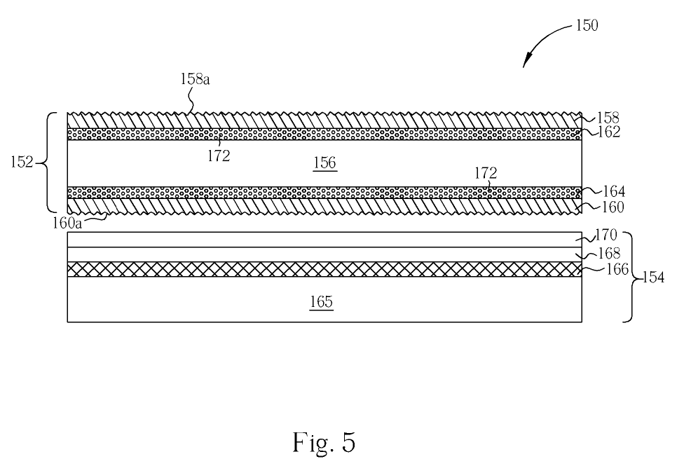

Please refer to FIG. 5. FIG. 5 is a cross-section of a display module 150 according to the fourth embodiment of the present invention. The display module 150 comprises a first part 152 and a second part 154. The first part 152 comprises a liquid crystal display panel 156, and the second part 154 mainly contains a back light module, which comprises a light source (not shown), a light guide plate 165, a diffusion film 166 and two prisms 168, 170. The upper and lower surfaces of the liquid crystal display panel 156 individually comprise an upper diffusion layer and a lower diffusion layer, which means both of the surfaces of a first polarizer 158 and a second polarizer 160 are rough surfaces. The fourth embodiment has the first and second polarizers 158, 160, a rough upper surface 158a, and a rough lower surface 160a to increase the scatter effect for reducing the optical interference. Furthermore, the first and the second adhesives 160, 164 of the first and the second polarizers 158, 160 can also be doped with spread particles 1 72, as FIG. 5 shown. The thickness of the upper and lower diffusion layer increases, which improves the scatter light effect and the display picture.

Please note that adjusting the rough angle or shape of the upper surface 158a and the lower surface 160a of the first or second polarizers 158, 160 can control the illumination, luminance, and micro-reflection of the display module 150, for increasing the picture quality of the display module 150.

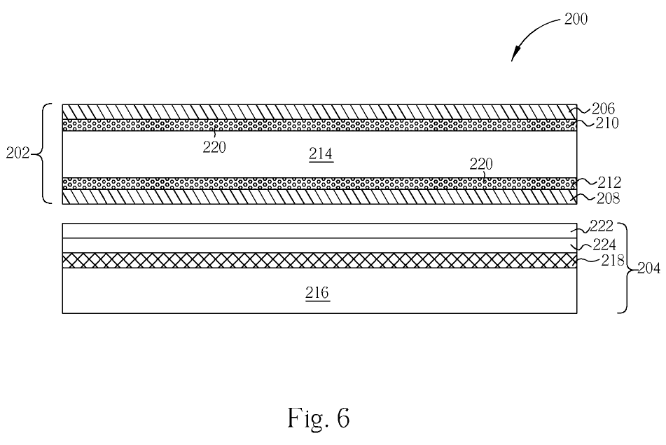

Please refer to FIG. 6. FIG. 6 is a cross-section diagram of a display module 200 according to the fifth embodiment of the present invention. As mentioned above, the display module 200 comprises a first part 202 and a second part 204. The second part 204 is a back light module, which comprises a light source (not shown), a light guide plate 216, a diffusion film 218 and two prisms 222, 224 with perpendicular patterns. The first part 202 comprises a liquid crystal display panel 214, which has an upper polarizer 206 and a lower polarizer 208 adhere to the upper surface and the lower surface of the liquid crystal display panel 214 individually. There is an upper diffusing adhesive 210 between the upper polarizer 206 and the liquid crystal display panel 214, and a lower diffusing adhesive 212 between a lower polarizer 208 and the liquid crystal display panel 214. The upper spread adhesive 210 and the lower spread adhesive 212 are used to adhere the upper polarizer 206 and the lower polarizer 208 with the surfaces of the liquid crystal display panel 214. The upper diffusing adhesive 210 and the lower diffusing adhesive 212 further have a scatter light function, which causes the light from the second part 204 and the liquid crystal display panel 214 to pass into the lower diffusing adhesive 212 and upper diffusing adhesive 210 in a scattered manner. That reduces the optical interference between the prisms 222, 224 and the liquid crystal display panel 214. The upper diffusing adhesive 210 and the lower diffusing adhesive 212 on the lateral sides of the liquid crystal display panel 214 in this embodiment serve as diffusion layers to achieve the goal of scattering light and for improving the picture quality caused by optical interference without any polarizers with rough surfaces. Besides, the manufacture of the upper diffusing adhesive 210 and the lower diffusing adhesive 212 is not restricted to doping the spread particles 220 into the general adhesive, and can also be made by other scattering materials.

In summary, the present invention reduces optical problems occurring in the prism of the back light module and flat display panel. The diffusion layer forms on the upper or lower surface of the flat display in the present invention for scattering light from the back light module so as to improve the picture quality. In the present invention, the diffusion layer can use a polarizer having a rough surface, a diffusing adhesive for adhering the polarizer, or use both in combination with each other. Comparing with the prior art, the present invention has no scatter film in the back light module, and as a result can reduce the required thickness. The present invention only modifies the existing material with a simple manufacturing process to achieve the goal of improving picture quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display comprising:
a flat display panel; and
at least one polarizer formed on an upper surface of the flat display panel or a lower surface of the flat display panel, the polarizer having at least one rough surface.

2. The display of claim 1, wherein when the polarizer is on the lower surface of the flat display panel, the rough surface is on the lower surface of the flat display panel, and when the polarizer is on the upper surface of the flat display panel, the rough surface is on the upper surface of the flat display panel.

3. The display of claim 1, wherein the display comprises two polarizers formed on the upper surface of the flat display panel and the lower surface of the flat display panel individually.

4. The display of claim 1, wherein the display further comprises a back light module, which comprises at least a prism beneath the flat display panel.

5. The display of claim 4, wherein the back light module further comprises at least a light source and a light guide plate, both being disposed under the prism and the flat display panel.

6. The display of claim 1, wherein the display further comprises a back light module, which comprises a light guide plate having a prism effect, the light guide plate being disposed under the flat display panel.

7. The display of claim 1, wherein the polarizer is adhered to the flat display panel surface by an adhesive.

8. The display of claim 7, wherein the adhesive is a diffusing adhesive, which is able to scatter light.

9. The display of claim 8, wherein the adhesive comprises a plurality of spread particles in the adhesive, and the spread particles scatter light.

10. The display of claim 9, wherein the thickness, shape, size, material, index of refraction and density of the spread adhesive influence the scatter light effect.

11. The display of claim 1 being a liquid crystal display.

12. A display module comprises:
an upper transparent substrate;
a lower transparent substrate disposed parallel with and beneath the upper transparent substrate;
a liquid crystal layer formed between the upper transparent substrate and the lower transparent substrate;
an upper polarizer adhered to an upper surface of the upper transparent substrate by an upper adhesive; and
a lower polarizer adhered to a lower surface of the lower transparent substrate by a lower adhesive;
wherein the upper adhesive or the lower adhesive is a diffusing adhesive, which is able to scatter light.

13. The display module of claim 12, wherein the duffusing adhesive comprises a plurality of spread particles in the spread adhesive.

14. The display module of claim 12, wherein the upper adhesive and the lower adhesive are diffusing adhesives.

15. The display module of claim 12, wherein the display module further comprises at least a prism disposed beneath the lower polarizer.

16. The display module of claim 15, wherein the display module further comprises at least one light source and a light guide plate, and the light source and the light guide plate are disposed under the prism.

17. The display module of claim 12, wherein the lower polarizer has a rough bottom surface.

18. The display module of claim 12, wherein the upper polarizer has a rough top surface.

19. A method of reducing optical interference of a display, wherein the display comprises a flat display panel and a back light module under the flat display panel, and the back light module comprises at least an optical film, the method comprising providing a diffusion layer on an upper surface of the flat display panel or a lower surface of the flat display panel to scatter light from the back light module and to reduce the optical interference.

20. The method of claim 19, wherein the diffusion layer is a diffusing adhesive, which is used for adhering a polarizer to the flat display panel surface.

21. The method of the claim 20, wherein the diffusion layer comprises a plurality of spread particles in the diffusing adhesive.

22. The method of claim 21, wherein the method comprising adjusting shape, size, material, index of refraction or density of the spread particle to control the scattering light effect.

23. The method of claim 19, wherein the diffusion layer is a polarizer with a rough surface.

24. The method of claim 23, wherein when the polarizer is on the lower surface of the flat display panel, the polarizer has a rough lower surface, and when the polarizer is on the upper surface of the flat display panel, the polarizer has a rough upper surface.

25. The method of claim 24, wherein the method comprising adjusting angle, shape or density of the rough upper or lower surface of the polarizer to control the illumination, luminance, and micro-reflection of the display.

26. The method of claim 19, wherein the diffusion layer comprises a polarizer with a rough surface and a diffusing adhesive, and the diffusing adhesive is used for adhere the polarizer to the flat display panel.

27. The method of claim 19, wherein the optical diaphragm is a prism.
